(19) United States
(12) Patent Application Publication
(10) Pub. No.: US 2018/0298606 A1
(43) Pub. Date: Oct. 18, 2018

(54) Facade Element and a Rail for the Facade Element

(71) Applicant: Brunkeberg Systems AB, Helsingborg (SE)

(72) Inventors: Henrik Falk, Stockholm (SE); David Simlund, Stockholm (SE)

(21) Appl. No.: 15/565,792

(22) PCT Filed: Apr. 8, 2016
(86) PCT No.: PCT/SE2016/050297

§ 371 Date: Oct. 11, 2017

(30) Foreign Application Priority Data
Apr. 13, 2015 (SE) 1550442-6
Apr. 13, 2015 (SE) 1550443-4
Apr. 13, 2015 (SE) 1550444-2

(51) Int. Cl. E04B 1/94; E04B 2/90; B66C 1/66

(52) U.S. Cl. CPC E04B 1/948; F21V 33/006; B66C 1/66; E04B 2/90

(57) ABSTRACT

The present invention relates to a façade element and a rail for façade elements. The façade element comprises a frame and façade material. The frame is provided to surround and hold the façade material. The frame has an upper side with a length (L) and an elongate recess with an undercut that extends at least along a major part of the length (L) of the upper side of the frame. The recess with the undercut is adapted to receive the rail in a locking engagement, such that when the rail is in an engaged state a L-shaped engagement portion of the rail is inserted in the recess of the frame and a shoulder of the rail rests on the upper side surface at one side of the recess and a locking mechanism of the lifting rail rests on an upper side surface at another side of the recess.

### TECHNICAL FIELD

The present disclosure relates to a façade element and lifting rail for lifting façade elements. The present disclosure also relates to a façade element and a mounting rail for retrofitting façade elements. The present disclosure also relates to a façade element and a fire protection rail for connection with the façade element. The present disclosure also relates to a façade element and a rail for engagement with the façade element.

### BACKGROUND ART

Multi-storey buildings can be constructed in a variety of ways. Common to all multi-storey buildings, however, is a façade element. The façade element can be constructed to constitute an integral part of the building as a load bearing component or it may only serve as a weather protective layer. There may of cause also be different combinations of façade elements with load bearing properties and weather protective layers. If the façade element only is used as a weather protective layer to seal the building then it is usually formed as a plate. In such a case the multi-story building comprises a building structure onto which the plate formed façade elements are attached.

It is common that the façade elements arrive at the working site on pallets. These pallets are then off-loaded by a tower crane, a mobile crane, a site hoist or the like and lifted to the floor of the multi-story building on which they are to be mounted. This step of lifting and installing façade elements is one of the most time consuming tasks when a new multi-storey building is built. Thus, by reducing this time it is possible to reduce the overall time it takes to complete the whole multi-storey building. A further drawback of the conventional construction method is that handling and storage of the façade elements occupies space on the construction site. Moreover, unloading, transporting and installation of the façade panels demand a lot of manual labor.

Brunkeberg Systems AB has developed an efficient method for mounting façade elements which substantially reduces the time to unload, lift and mount façade elements on a building structure of a multi-storey building. According to the method, which is disclosed in WO2010070082, façade elements are transported on a conveyer directly from a delivery truck to a multi-storey building. The façade elements are then hoisted by an elevator unit, i.e. a crane, whilst inserted in slots of guiding rails mounted on the building structure, i.e. the vertical edges of the façade element will run in slots while hoisted. This will make the hoisting procedure less sensitive to weather conditions, such as wind, since the façade elements run steadily in the slots. The guiding-rails are mounted on the building structure all the way up to the floor that is beneath the floor to be mounted, i.e. with this method the façade elements are mounted from the bottom and up. When the façade elements have reached the floor on which they are to be mounted they are pushed in a horizontal direction towards the building and attached appropriately to the building.

In the method disclosed in WO2010070082, the façade elements are moved from the conveyor to the guiding rails by an elevator unit provided with a gripping device for gripping the façade element. In operation, the elevator unit angles out such that the gripping may grip the façade element. As the elevator unit then moves upwards the façade element is moved inwards towards the building and enters into the guiding rails.

The gripping device may also first be moved into a gripping position whereby the façade elements subsequently are moved into engagement with the gripping device.

However, although the gripping device of WO2010070082 has proved to be useful, it suffers from some drawbacks. In particular it is bulky and it is cumbersome and time consuming to move the gripping device in position for gripping a façade element.

An alternative to using a gripping device is to provide the façade elements with two eyebolts. The two eyebolts are arranged at the two upper corners of the façade element and adapted to receive a hook that is fastened to a wire of a crane. The façade element comprises a façade material, which may be glass (windows), concrete, or any other suitable material or combinations of materials. The material is surrounded and held by a frame into which frame the eyebolts are fastened. This solution with eyebolts and hooks is the predominating way of lifting façade element today. One problem with this procedure is that the frame has to be designed to withstand high loads, especially point loads at the upper corners of the frame. In fact it is these high point loads when lifting the façade element that determine the dimensions of the frame and thus the whole façade element.

Thus, it is an object of the present invention to achieve a façade element with dimensions that are limited by the conditions that prevail when mounted to the building structure and not by the lifting process. In particular, it is an object of the present invention to achieve a façade element with thinner frames than are used today. A further object of the present invention is to achieve a lifting device for engagement with the façade element, which in an easy way may be connected to a crane, a lifting jig or the like.

A further problem in the construction of buildings relates to interior furnishing. When the façade elements have been mounted onto the building structure for one floor, the interior work of that floor may start, i.e. equip and decorate the floor. One of the final decorating tasks is to hang curtains and the like. Usually one uses different curtain rods which are fastened to the façade element. One disadvantage with this procedure is that it might damage the façade element and weaken its structural strength. It is therefore common to design façade elements with a security margin due to damage caused to the façade element when decorating the interior of the building. This will of course make the façade elements both heavier and more bulky than necessary, which in the end leads to a more expensive building process.

Thus, it is an object of the present invention to achieve a façade element with dimensions that are limited by the conditions that prevail when mounted to the building structure and not by stress that is caused when decorating the interior of the building. In particular, it is an object of the present invention to achieve a façade element with thinner frames than are used today. A further object of the present invention is to achieve a mounting rail for engagement with the façade element, which mounting rail easy may be retrofitted with curtains, illumination etc.

A further problem in the construction of buildings relates to fire protection. When the façade elements have been mounted onto the building structure for one floor, the interior work of that floor may start, i.e. equip and decorate the floor. One important task is to accomplish fire protection between the different floors of the multi-storey building. Typically this is done by spraying some foam that will need to cure or use some other type of sealing and together with some adhesive. These materials are not always healthy to deal with and it also takes time provide the fire sealing between the floors of the building. The sealing is also sometimes mounted onto the façade element which might damage the façade element. The façade element therefore needs to be designed with greater dimensions then is actually necessary for withstanding the weather and wind conditions.

Thus, it is an object of the present invention to achieve a façade element which facilitates the installation of fire sealing between the floors. In particular, it is an object of the present invention to achieve a façade element which does not have to be dimensioned to take into account damages caused by installing fire protection. A further object of the present invention is to achieve a fire protection rail for engagement with the façade element, which fire protection rail easy may be retrofitted to the façade element without causing damages.

### SUMMARY OF THE INVENTION

According to a first aspect of the present disclosure at least one of these objects is achieved by a façade element, comprising a frame and façade material, wherein the frame is provided to surround and hold the façade material. The frame has an upper side with a length L. An elongate recess with an undercut is extending at least along a major part of the length L of the upper side of the frame. The recess with the undercut is adapted for receiving a lifting rail in a locking engagement.

According to a second aspect of the present disclosure at least one of these objects is achieved by a façade element comprising a frame and façade material, wherein the frame is provided to surround and hold the façade material. An upper part of the façade element has a length L, said upper part being provided with a mounting area. An elongate recess with an undercut is extending at least along a major part of the length L of the upper part of the frame, said recess with the undercut being adapted for receiving a mounting rail in a locking engagement.

According to a third aspect of the present disclosure at least one of these objects is achieved by a façade element comprising a frame and façade material, wherein the frame is provided to surround and hold the façade material. The frame has an elongate recess with an undercut is extending along a width W of the façade element, on the side of the façade element that is facing an interior of a building onto which the façade element is mounted, said recess with the undercut being adapted for receiving a fire protection rail in a locking engagement.

According to a fourth aspect of the present disclosure at least one of these objects is achieved by a façade element comprising a frame and façade material, wherein the frame is provided to surround and hold the façade material. The façade element has a side with a length (L). An elongate recess with an undercut extends at least along a portion of the length (L) of the side of the façade element. The recess with the undercut being adapted for receiving a rail (20) in a locking engagement.

The elongate recess of the façade element may according to one embodiment extend along the entire length of the upper side of the façade element

According to some embodiments the façade element may be provided with a recess that is substantially L-shaped or a recess that is substantially anchor-shaped.

According to a fifth aspect of the present disclosure at least one of these objects is achieved by a lifting rail for lifting a façade element. The façade element comprises a frame and façade material. The frame is provided to surround and hold the façade material, said frame having an upper side with a length L. The lifting rail comprises a L-shaped engagement portion, a shoulder and a locking mechanism, which all are adapted to be received by and in locking engagement with an elongate recess of the façade element. The recess is formed with an undercut and extends at least along a major part of the length of the upper side of the frame, the length of the recess corresponding to the a length of the lifting rail. When the lifting rail is in an engaged state the L-shaped engagement portion is inserted in the recess of the frame and the shoulder rests on an upper side surface at one side of the recess and the locking mechanism rests on an upper side surface at another side of the recess.

According to a sixth aspect of the present disclosure at least one of these objects is achieved by a mounting rail for retrofitting a façade element. The façade element comprises a frame and façade material. The frame is provided to surround and hold the façade material. An upper part of the façade element has a length L, said upper part being provided with a mounting area. The mounting rail comprises a L-shaped engagement portion, a shoulder and a locking mechanism, which are adapted to be received by and in locking engagement with an elongate recess of the façade element. The recess is provided with an undercut and extends at least along a major part of the upper part of the frame.

The length of the recess corresponds to a length of the mounting rail, such that when the mounting rail is in an engaged state the L-shaped engagement portion is inserted in the recess of the frame and the shoulder rests on a surface of the upper part at one side of the recess and the locking mechanism rests on a surface of the upper part at another side of the recess.

According to a seventh aspect of the present disclosure at least one of these objects is achieved by a fire protection rail for engagement with a façade element. The façade element comprises a frame and façade material, wherein the frame is provided to surround and hold the façade material The fire protection rail comprises a L-shaped engagement portion, a shoulder and a locking mechanism, which are adapted to be received by and be in locking engagement with an elongate recess of the frame. The recess has an undercut and extending along the entire width W of the façade element, the length of the recess corresponding to a length of the fire protection rail, such that when the fire protection rail is in an engaged state the L-shaped engagement portion is inserted in the recess of the frame and the shoulder rests on a surface of the façade element that is facing an interior of a building onto which the façade element is to be mounted and the locking mechanism rests on the same surface, but at the opposite side of the recess.

According to an eight aspect of the present disclosure at least one of these objects is achieved by a rail for a façade element, said façade element comprising a frame and façade material, wherein the frame is provided to surround and hold the façade material. The façade element has a side with a length (L). The rail comprises a L-shaped portion, a shoulder and a locking mechanism, which are adapted to be received by and in locking engagement with an elongate recess of the façade element. The recess has an undercut and extends at least along a portion of the side of the façade element. The length of the recess corresponds to a length of the rail. When the rail is in an engaged state, the L-shaped engagement portion is inserted in the recess of the frame and the shoulder rests on an upper side surface at one side of the recess and the locking mechanism rests on a side surface at another side of the recess.

Furthermore, the locking mechanism is pivotable between an open position, in which the rail is insertable into the recess of the frame and a locked position, in which is the rail is in locking engagement with the recess of the frame.

According to an exemplary embodiment the locking mechanism is provided with a spring biased locking ball adapted to engage a cavity of the rail, when the locking mechanism is in the locked position.

With a façade element according to the first aspect provided with a recess having an undercut the frame of the façade element may be designed with smaller dimensions then is customary. Since the load, when lifting the façade element, now is distributed along a major part of the length of the upper side of the frame the lifting procedure is no longer limiting the design and dimensions of the frame. Thus, by altering the way to lift façade elements it is now possible to design much thinner and also much wider façade elements, which is advantageous to the building process.

Additionally, with a façade element according to the second aspect provided with a recess having an undercut the frame of the façade element may be designed with smaller dimensions then is customary, since one now no longer need to damage the façade element when decorating the interior of the building.

Additionally, with a façade element according to the third aspect provided with a recess having an undercut the façade element may be easily retrofitted with a fire protection rail. Furthermore, the frame of the façade element may be designed with smaller dimensions then is customary, since one now no longer need to damage the façade element when installing fire protection between the floors of the building.

By using a lifting rail according to the fifth aspect having substantially the same length as the elongate recess and which is designed to interact with the undercut of the elongate recess spot loads are avoided.

Additionally, by using a mounting rail according to the sixth aspect that it inserted into the elongate recess it is possible to retrofit the façade element with curtain hangers, illumination and other interior decoration items without having to damage the façade element. Furthermore, the time to fit the mounting rail by “snapping” it into to the recess and turning the locking mechanism is negligible compared to the traditional way to decorate the inside of the building, which requires measuring, drilling, fixing etc.

Additionally, by using a fire protection rail according to the seventh aspect that it inserted into the elongate recess it is possible to retrofit the façade element with fire protection without out the need to use hazardous materials. Furthermore, the time to fit the fire protection rail by “snapping” it into to the recess and turning the locking mechanism is negligible compared to the traditional way to install fire protection.

### BRIEF DESCRIPTION OF DRAWINGS

The invention will now be described in detail with reference to the accompanying drawings, in which

FIG. 1 shows a schematic view of an exemplary embodiment of a façade element according to the first aspect of the present disclosure;

FIG. 2 shows a schematic view of an exemplary embodiment of a façade element according to the second aspect of the present disclosure;

FIG. 3 shows a schematic view of an exemplary embodiment of a façade element according to the third aspect of the present disclosure;

FIG. 4 is an enlarged side view of an upper side of the façade element according to the first aspect of the present disclosure, showing an exemplary L-shaped recess;

FIG. 5 is an enlarged side view of the upper side of the façade element according to the first aspect of the present disclosure, showing an exemplary anchor-shaped recess;

FIG. 6 shows a perspective view of a lifting rail according to the fifth aspect of the present disclosure;

FIG. 7 shows an enlarged side view of the lifting rail according to the fifth aspect of the present disclosure;

FIG. 8 shows a perspective view of a mounting rail according to the sixth aspect of the present disclosure;

FIG. 9 shows an enlarged side view of the mounting rail according to the sixth aspect of the present disclosure;

FIG. 10 shows a perspective view of a fire rail according to the seventh aspect of the present disclosure;

FIG. 11 shows a side view of the fire rail according to the seventh aspect of the present disclosure;

FIGS. 12-14 show enlarged views of different steps of the procedure of when lifting rail is brought into locking engagement with the recess of the façade element;

FIG. 15 shows a partial front view of the lifting rail, with the locking mechanism according to a first embodiment of the present disclosure in an open position, and

FIG. 16 shows a partial front view of the lifting rail, with the locking mechanism according to the first embodiment of the present disclosure in a locked position;

FIG. 17 is an exploded view of a lifting rail with a locking mechanism according to a second embodiment of the present disclosure;

FIG. 18, 19 shows a side view of the lifting rail with a locking mechanism according to the second embodiment of the present disclosure in open and closed position respectively;

FIG. 20, 21 shows the front side and the back side of the lifting rail with a locking mechanism according to the second embodiment of the present disclosure in closed position;

FIG. 22, 23 shows the front side and back side of the lifting rail with a locking mechanism according to the second embodiment of the present disclosure in open position;

### DETAILED DESCRIPTION OF THE EMBODIMENTS

Embodiments of the present disclosure will be described in more detail below with reference to the accompanying drawings in order for those skilled in the art to be able to carry out the invention. The disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

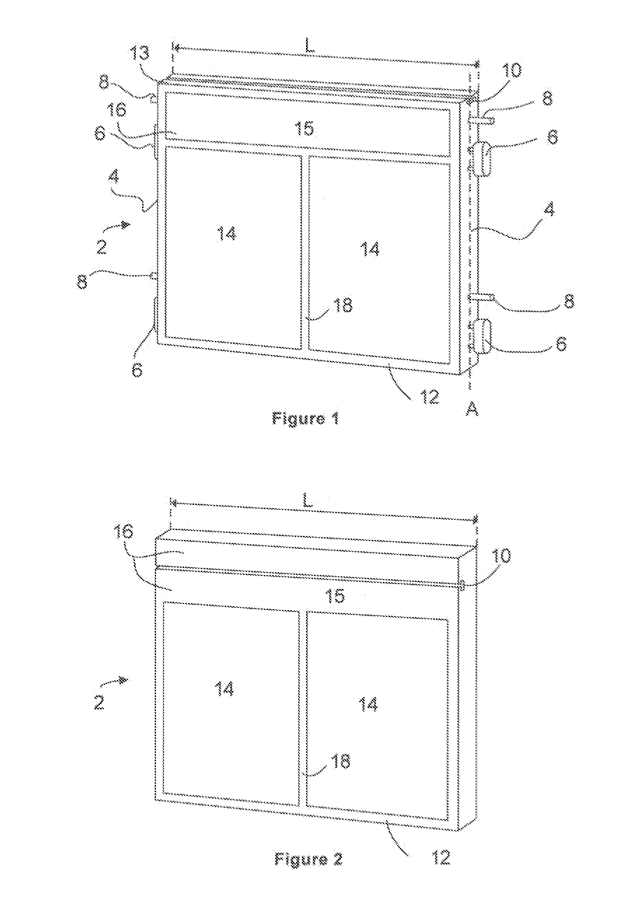

FIG. 1 shows a schematic view of an exemplary embodiment of a façade element 2 according to the first aspect of the present disclosure. The façade element 2 comprises two vertical sides 4, guiding blocks 6, guiding pins 8, a recess 10, a frame 12, an upper side 13, an upper part 16, façade material 14, 15 and a reinforcement frame 18. The main components of the façade element 2 are the façade material 14, 15 and the frame 12. The façade material may by any material suitable used for building multi-story buildings, such as glass, concrete, metal, bricks, insulation etc. The façade element 2 may comprise one or more façade materials in different combinations. In the exemplary embodiment of the façade element 2 in FIG. 1, the façade material comprises glass (windows) 14 and a combination of aluminum and insulation 15. The aluminum/insulation combination corresponds in this exemplary embodiment to the ceiling structure of the building, i.e. it will cover the ceiling structure when mounted to the building structure.

The façade material 14, 15 is surrounded and held by the frame 12. In the exemplary embodiment disclosed in FIG. 1, the façade element 2 is further reinforced by the T-shaped reinforcement frame 18. The use of such a reinforcement frame 18 is optional and depends on which size the façade element 2 has. As is realized by a person skilled in the art there may be numerous ways to design reinforcement frame 18 and it is believed to be within in the capabilities of such a person to design a suitable reinforcement frame taking the dimensions of the façade element into account. However, there may also be other considerations than strength, such as the appearance of a façade element 2, when designing the reinforcement frame.

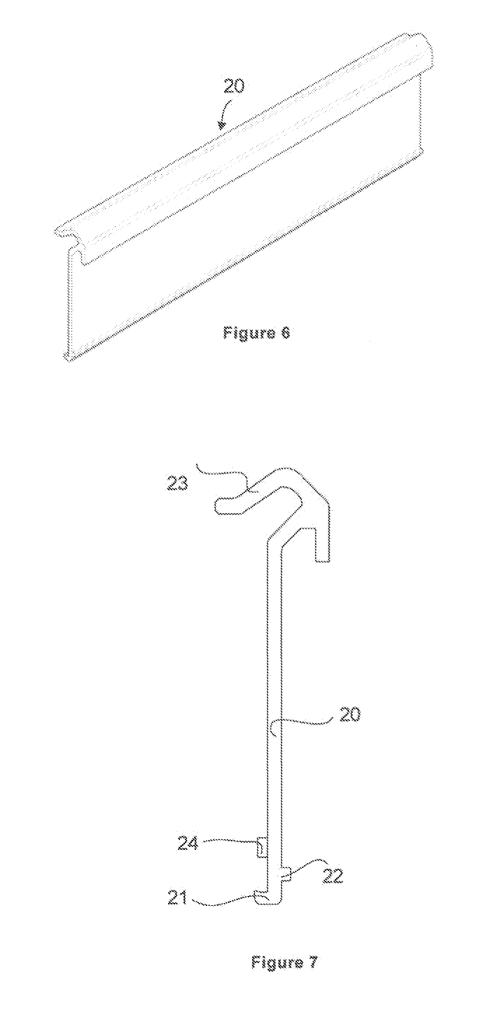

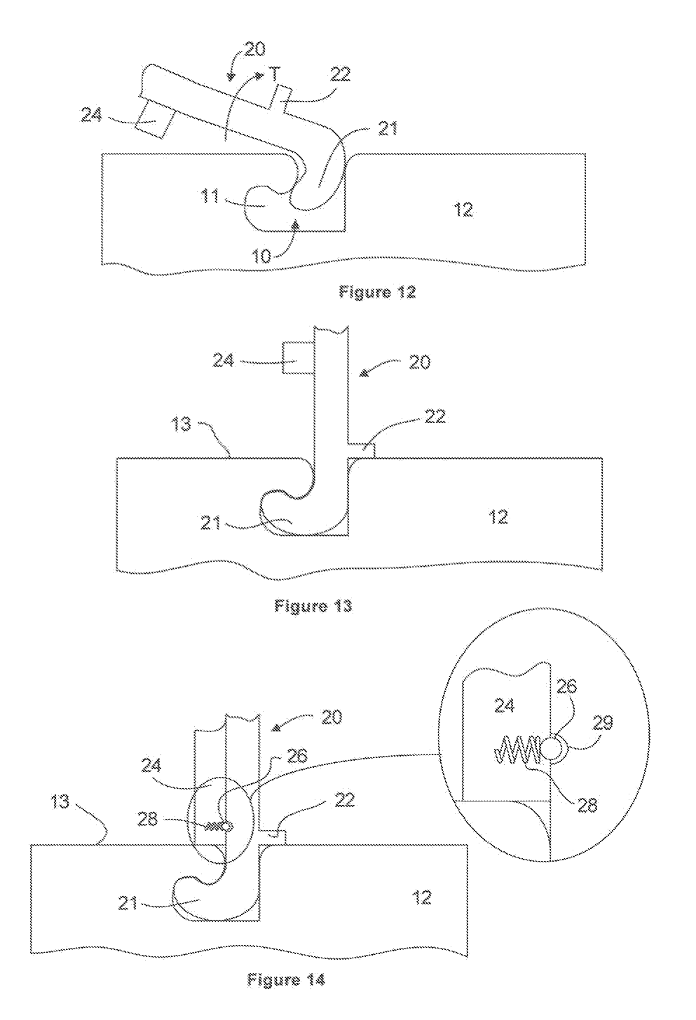

The upper side 13 of the façade element 2 is provided with a recess 10 and has a length L. The recess 10 is designed and adapted to receive a lifting rail, with help of which the façade element 2 may be lifted to its mounting position. The recess will be closer described in conjunction with FIGS. 4 and 5 and the lifting rail will be closer described in conjunction with FIGS. 6 and 7. The interaction between the recess 10 and the lifting rail and how they are brought into a locking engagement is closer described in conjunction with FIGS. 12 to 14.

As mentioned above the façade element 2 further comprises guiding blocks 6 and guiding pins 8 provided at the vertical sides 4 of the façade element 2. The guiding pins 8 are adapted to cooperate with a mounting tool used to guide the façade element 2 into its final position when mounting it to the building structure. This process is closer described in a co-pending Swedish patent application no. 1451229-7. The façade element 2 is furthermore provided with guiding blocks 6 on the vertical side 4 of the façade element 2. As is apparent in FIG. 1, the guiding blocks 6 are provided on the same vertical line A as the guiding pins 8. The horizontal width or extension of the guiding blocks 6 is greater than the diameter of the guiding pins 8. The function of the guiding blocks 6 are also described closer in the above referenced co-pending Swedish patent application.

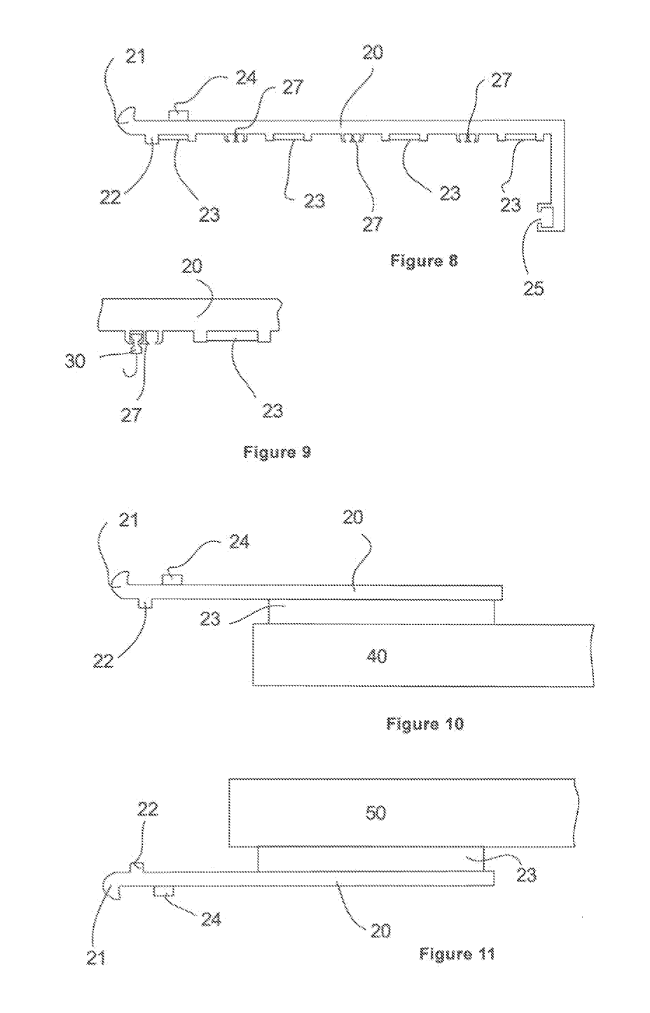

FIG. 2 shows a façade element according to the second aspect of the present disclosure. The upper part 16 of the façade element 2 is provided with a recess 10 and has a length L. The recess 10 is designed and adapted to receive a mounting rail, with help of which the façade element 2 may be retrofitted with curtain hangers, illumination etc. The recess 10 is identical to the recess in the façade element according to the first aspect of the present disclosure and will therefore be closer described in conjunction with FIGS. 4 and 5. The mounting rail will be closer described in conjunction with FIGS. 8 and 9. The interaction between the recess 10 and the mounting rail is identical to the interaction between the recess 10 and the lifting rail. How these parts are brought into a locking engagement is therefore closer described in conjunction with FIGS. 12 to 14.

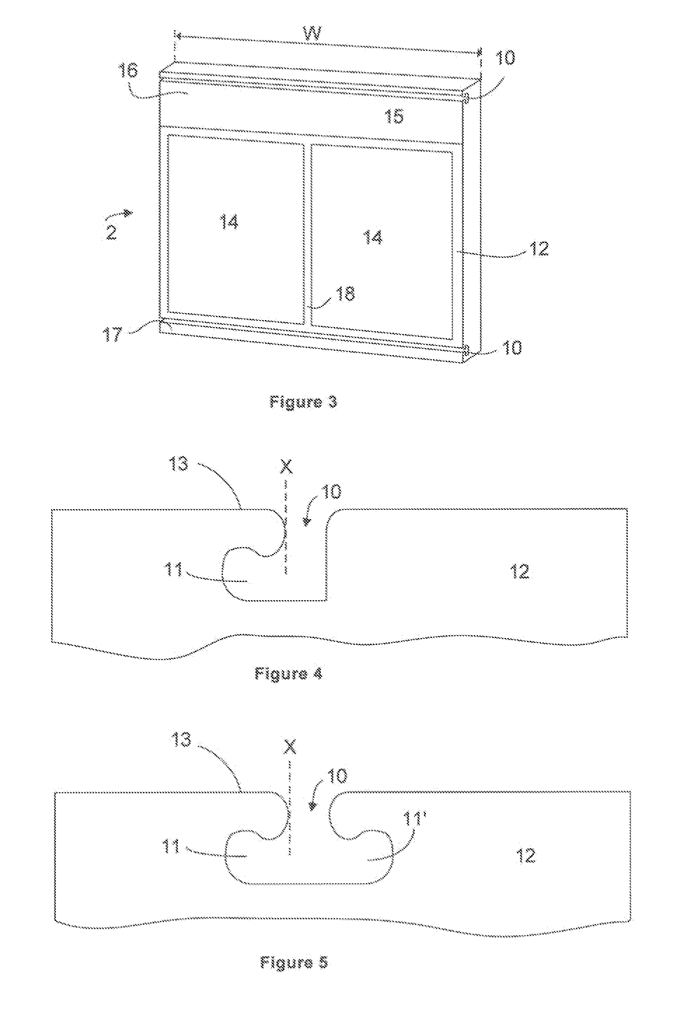

FIG. 3 shows a façade element according to the third aspect of the present disclosure. The façade element 2 in FIG. 1 is provided with two recesses 10 along the entire width W of the façade element 2. There is actually only necessary with one recess depending if a fire protection rail 20 is to seal against the floor or against the ceiling. The 10 recess at the lower part 17 is used for sealing against the floor and the recess 10 at the upper part is used to seal against the ceiling. The recess 10 is designed and adapted to receive a fire protection rail, with help of which the façade element 2 may be retrofitted with fire protection. The recess 10 is identical to the recess in the façade element according to the first aspect of the present disclosure and will therefore be closer described in conjunction with FIGS. 4 and 5. The fire protection rail will be closer described in conjunction with FIGS. 10 and 11. The interaction between the recess 10 and the fire protection rail is identical to the interaction between the recess 10 and the lifting rail. How these parts are brought into a locking engagement is therefore closer described in conjunction with FIGS. 12 to 14.

Other features of the façade element of the second and the third aspect are identical to the features of the façade element of the first aspect.

Turning now to FIG. 4 an exemplary embodiment of the recess 10 will be described. The recess 10 is provided on the upper side 13 of the frame 12. However, as mentioned the recess 10 may also be provided on the upper and/or the lower part 16, 17 of the façade element. It is further appreciated that the recess 10 may be provided on other areas of the façade element, such as the sides 4 for instance. FIG. 4 shows an enlarged side view of the upper side 13 of the façade element 2. The recess 10 is provided with an undercut 11, i.e. it has a hollow space under the surface 15 of the upper side 13 of the frame 12. The undercut 11 is, in the embodiment of FIG. 2, defined as being the hollow space that is to the left of an axis X that is perpendicular to the upper side 13 and running adjacent to the opening of the recess 10. The undercut 11 is an important feature when bringing the lifting rail into locking engagement with the recess 10 as will be explained further below. The shape of the recess 10 as seen in the enlarged side view of FIG. 4 may be defined as L-shaped or boot-shaped.

FIG. 5 shows another exemplary embodiment of the recess 10. In this embodiment the recess 10 is provided with two undercuts 11, 11′ instead of one. The principles for the undercut are the same as in FIG. 2 and will therefore not be described again. The second undercut 11′ in FIG. 5 is a mirror image of the first undercut 11 in FIG. 4, which gives the recess 10 an anchor-like shape or upside-down T-shaped. One advantage with having a recess with double undercuts is that the lifting rail may be inserted into the recess 10 from two different directions, which may be beneficial during the lifting process of the façade elements 2. As is understood by a person skilled in the art, the recess may be designed in a variety of ways. As mentioned above it is import that the recess has an undercut in order to create a locking engagement with the lifting rail. The important feature is that the undercut is adapted such as it may receive the lifting rail 20, and especially the engagement portion 21 of the lifting rail 20. In the described embodiments the engagement portion 21 of the lifting rail 20 is shown as L-shaped, but may for example also be J-shaped or any other suitable shape adapted for locking engagement with a mating recess 10 having an undercut 11.

FIG. 6 shows a perspective view of a lifting rail 20 according to the fifth aspect of the present disclosure. FIG. 7 shows an enlarged side view of the lifting rail 20, having J-shaped profile. The lifting rail 20 comprises an engagement portion 21, a shoulder 22, a hook 23 and locking mechanism 24. The lifting rail 20 may be manufactured in aluminum, steel or any other suitable metal or material with the mechanical properties for lifting a façade element 2. The hook 23 is adapted to be received by some kind of lifting device, such as a lifting rig also having a J-shaped rail for lifting the façade element 2 in the lifting rail. The functions of the different features of the lifting rail 20 will be described below in conjunction with FIGS. 12 to 16. FIGS. 12 to 14 show enlarged views of different stages of the procedure when the lifting rail 20 is brought into locking engagement with the recess 10 of the façade element 11. It is appreciated that the engagement portion 21 may also be denominated “lifting portion 21”.

FIG. 8 shows a side view of a mounting rail 20 according to the sixth aspect of the present disclosure. FIG. 9 shows an enlarged side view of the mounting rail 20. The mounting rail 20 comprises an engagement portion 21, a shoulder 22, illumination 23, locking mechanism 24 and different fastening means 25, 27 for different types of curtain hangers and the like. The mounting rail 20 may be manufactured in aluminium, steel or any other suitable metal or material with the mechanical properties for lifting a façade element 2. The illumination may be fitted in between two lips. In the example embodiment in FIG. 8, there is provided four illumination sources, but this number as understood by a person skilled in art a design option when designing the mounting rail. The different fastenings means 25, 27 are adapted to receive different type of curtain hangers or other interior decorations elements. In the exemplary embodiment in FIG. 9 a curtain hanger 28 with a hook is provided onto which a curtain may be hanged. The hook may be fastened to a rail that extends the whole length of the mounting rail 20. Typically the mounting rail 20 has the same length as the length L of the façade element 2, i.e. the width of the façade element 2.

FIG. 10 shows a side view of a fire protection rail 20 according to the seventh aspect of the present disclosure mounted to a floor structure 40 of a building. The fire protection rail 20 comprises a engagement portion 21, a shoulder 22, a fire protection sealing 23, a locking mechanism 24. The fire protection rail 20 may be manufactured in aluminium, steel or any other suitable metal or material with the properties for sealing the space between two floors. The fire protecting sealing 23 may be any suitable fire sealing on the market. In some exemplary embodiments the fire protection rail 20 may be screwed onto the floor structure 40 to increase the sealing pressure. As mentioned above the fire protection rail 20 has the same length as the length as the width W of the façade element 2.

FIG. 11 shows an enlarged side view of the fire protection rail 20 mounted to a ceiling structure 50 instead of the floor structure. Other then that there are no differences between the embodiments in FIGS. 10 and 11 and the description there of is not repeated once again.

Mounting of the lifting rail 20 according to the fifth aspect of the present disclosure into a recess 10 of the façade element will in the following be described with reference to FIGS. 12-14. However, it is appreciated that the mounting rail and the fire protection rails according to the sixth and seventh aspects of the present disclosures are mounted in that same way as the lifting rail.

In FIG. 12 a first stage of the locking engagement between the lifting rail 20 and the recess 10 is shown. In this stage the lifting rail 20 is angled and the L-shaped engagement portion 21 of the lifting rail 20 is inserted into the recess 10. As soon as the L-shaped engagement portion has been inserted into the recess 10, the lifting rail 21 is rotated in the direction of the arrow T into an upright position, i.e. perpendicular to the surface of the upper side 13 of the frame 12. During this movement the L-shaped engagement portion 21 will slide into the undercut 11.

In FIG. 13 the lifting rail 20 is shown in its upright position. In this position the upper part of the L-shaped recess 10 is almost completely filled out by the L-shaped engagement portion 21. The shoulder 22 of the lifting rail 20 is designed such that it abuts the surface of the upper side 13 of the frame 12 when the lifting rail 20 has reached its final upright position. In this position the lifting rail 20 cannot be rotated anymore in the direction of arrow T, since the abutment of the shoulder 22 works as a stopper for the rotational movement in the direction of arrow T. Also the design of the L-shaped engagement portion 21 of the lifting rail 20 and the undercut 11 of the recess 10 acts as a stopper, since the L-shaped engagement portion 21 will abut the surface of the undercut 11 when the lifting rail 20 is in its final upright position. Thus, the lifting rail 20 is securely fixed into recess 10 and may withstand forces applied in the direction of the arrow T. However, if forces are applied in an opposite direction of the arrow T the lifting rail 20 will reverse its previous movement and fall out of the recess 10. To prevent such a movement and securely fix the lifting rail 20 in the upright position the lifting rail 20 is provided with a locking mechanism 24. In FIG. 13 the locking mechanism 24 according to the first embodiment of the present disclosure is shown in an open position, i.e. the lifting rail 20 has not been securely fixed into the recess 10.

Turning now to FIG. 14 the locking mechanism 24 is shown in a locked position. In FIG. 8, the area of the locking mechanism 24 is also shown in an enlarged view in order to better understand how the looking mechanism 24 functions. The locking mechanism 24 may be a block that is pivotally attached to the lifting rail 20. When the locking mechanism 24 is in its closed position one end surface of the locking mechanism 24 is in abutment with the surface of the upper side 13 of the frame 12. In this position the lifting rail 20 is in a locking engagement with the recess 10. In a preferred embodiment the locking mechanism 24 may furthermore be provided with a spring-biased ball 26. The spring-biased ball 26 is adapted to interact with a cavity 29 provided on the lifting rail 20. The cavity 29, the ball 26 and the spring 28 are best shown in the enlarged view of FIG. 8. When the locking mechanism 24 is turned from the open position to the locking position the spring 28 will push the ball 28 into the cavity 29 when the locking mechanism 24 has reached its final position and thereby securely fix the lifting rail 20 into the recess 10. As realized by a person skilled in the art there may be many other ways of securing the locking mechanism 24 in its locking position, such as spring-biased pins, pins and holes or a groove in the lifting rail adapted to receive the locking mechanism when it is in its final position etc. It is of course also possible to provide the spring-biased ball on the lifting rail and the cavity in the locking mechanism instead.

Even if the steps of engagement between the lifting rail 20 and the recess 10 in FIGS. 12 to 14 relate to a recess having a L-shaped cross section, the steps are of course also applicable for the anchor shaped recess shown in FIG. 5 or any other suitable recess having an undercut.

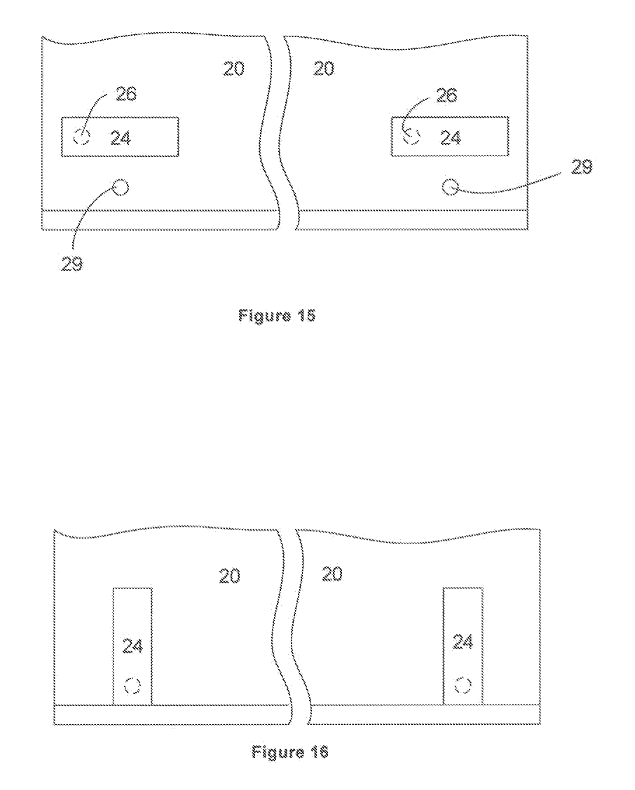

FIG. 15 and FIG. 16 show a partial front view of the lifting rail with the locking mechanism 24 in is its open and locking position, respectively. The spring biased-ball 26 is indicated in the figures by dotted lines, since it is hidden by the locking mechanism 24 in FIGS. 15 and 16. In FIGS. 15 and 16 the full length of the lifting rail 20 is not show, but only the two ends where the locking mechanisms 24 are provided. The number of locking mechanisms 24 depends on the length of the lifting rail 20, and is preferably two for a façade element with a width (same as length of upper side 13) of 3 m. The length of the lifting rail 20 may in a preferred embodiment correspond to the length L of upper side 13 of the frame 12. Using the whole length L of upper side 13 of the frame will distribute the lifting load along the entire length L, which makes it possible to reduce the dimensions of the frame 12 with regard to the lifting forces it has to withstand. In other embodiments of the lifting rail 20 the length of the lifting rail 20 may correspond to ⅔ of the length L of the upper side of the frame 12. It is preferred that the lifting rail is at least half, i.e. a major part, of the length L of the upper side 13 of the frame 12.

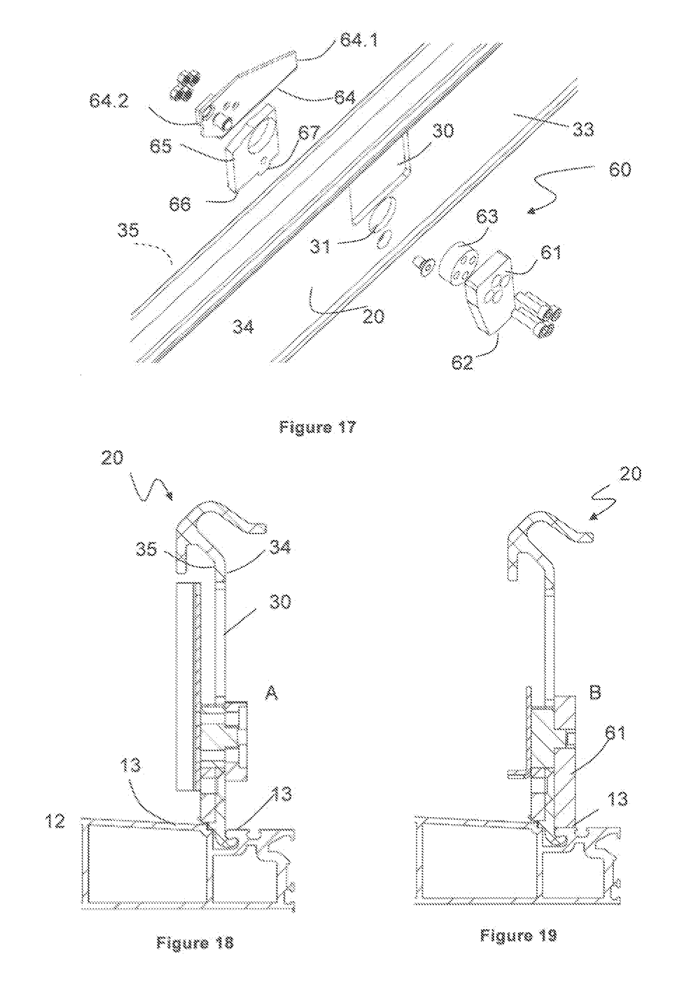

In the following a alternative lifting rail 20 and a locking mechanism according to a second embodiment of the present disclosure will be described with reference to FIGS. 17-19.

FIG. 17 shows a portion of an alternative lifting rail 20 and an exploded view of a locking mechanism 60 according to a second embodiment of the disclosure.

The lifting rail 20 is shown in side view in FIG. 18 and is identical to the lifting rail 20 described in FIGS. 4 and 5. Thus, the lifting rail 20 is elongate and has a first side 34 and a second side 36. The lifting rail 20 is further of J-shaped profile and comprises an engagement portion 21, a shoulder 22 and a hook 23 for engagement with a lifting device (not shown). Returning to FIG. 17, the lifting rail 20 further comprises a vertical portion 33 which extends between the hook 23 and the shoulder 22. At least one opening 30 is arranged in the vertical portion 33 of the lifting rail 20. The opening 30 may be arranged anywhere along the length of the lifting rail. However, preferably the opening 30 is arranged at the centre of the lifting rail. The lifting rail 20 further comprises a locking mechanism 60 for securing the lifting rail 20 in upright position when its engagement portion 21 is engagement with the recess 10 of a façade element. The locking mechanism 60 comprises a first pivotable locking element 61 which is arranged on the first side 34 of the lifting rail. The first locking element 61 is elongate rectangular and has an abutment surface 62 for abutment with the upper surface 13 of the façade element. The locking element 61 is pivotally attached to the lifting rail and configured such that it may be swung from a first, horizontal, position A in which the abutment surface 62 is free of contact with the upper surface 13 of the façade element to a second, vertical, position B in which the abutment surface 62 is in contact with the upper side 13 of the façade element and presses thereon. FIG. 18 shows the first locking element 61 in position A and FIG. 19 shows the first locking element 61 in position B.

It is appreciated that above and hereinafter is by “vertical position” meant that the first locking element 61 is oriented such that the abutment surface 62 is directed towards the engagement portion 21 of the lifting rail. By “horizontal position” is meant that the first locking element 61 is oriented 90° to the vertical position.

The pivotal arrangement of the first locking element 61 facilitates mounting of lifting rail 20 in a façade element. Thus, when the first locking element 61 is in horizontal position A, there is sufficient space between the first locking element 61 and the upper surface 13 of the façade element 10 to allow the engagement portion 21 of the lifting rail 20 to be inserted into the recess 10 of the façade element (see FIG. 6).

The abutment surface 62 is slightly curved, i.e. it has a radius. This ensures that the abutment surface 62 always may be brought into firm contact with the upper surface 13 of the façade element even when there are differences in tolerances between the lifting rail 20, the locking element 61 and/or the façade element.

The locking element 61 may be pivotally attached to the lifting rail by a shaft 63 which extends through the lifting rail 20. The shaft 63 is arranged pivotal in a second opening 31 in the lifting rail. The locking element 61 is thereby firmly attached to the shaft 63.

The locking mechanism 60 may further comprise a handle 64 which is arranged on the second side 35 of the lifting rail. The handle 64 is elongate and has opposing first and second ends 64.1, 64.2. The handle 64 is firmly attached by one of its opposing ends to the shaft 63, such that turning of the handle 64 results in pivotal motion of the first locking element 61. Thus, the handle 64 is coupled to the first locking element 61 by the shaft 63. The handle 64 provides leverage and enables a worker at the building site to pivot the first locking element 61 into strong abutment contact with upper side 13 of the façade element. The shaft 63 may be a separate part (as shown in FIG. 17) or integral with one or both of the handle 64 and the first locking element 61 (not shown).

The shaft 63 is preferably arranged below the first opening 30 in the lifting rail. The handle 64 and the locking element 61 are thereby preferable joined to the shaft 63 such that the handle 64 is in a horizontal position A when the locking element 61 is in a vertical position B and such that the handle is in a vertical position B when the locking element 61 is in a horizontal position A. The first opening 30 is thereby configured, i.e by shape and size, such that at least a section of the handle 64 is visible through the opening when the handle is in vertical position. Thus, the handle 64 and the first opening 30 are configured by e.g. size, position and design such that the handle 64, in vertical position, extends over at least a portion of the opening 30 and such that the handle, in horizontal position, does not extend over the opening 30.

It is appreciated that above and hereinafter is by “vertical position” of the handle 64 meant that the handle 64 is oriented such that its free end 64.1 is directed towards the hook 23 of the lifting rail. By “horizontal position” is meant that the handle is oriented 90° to the vertical position.

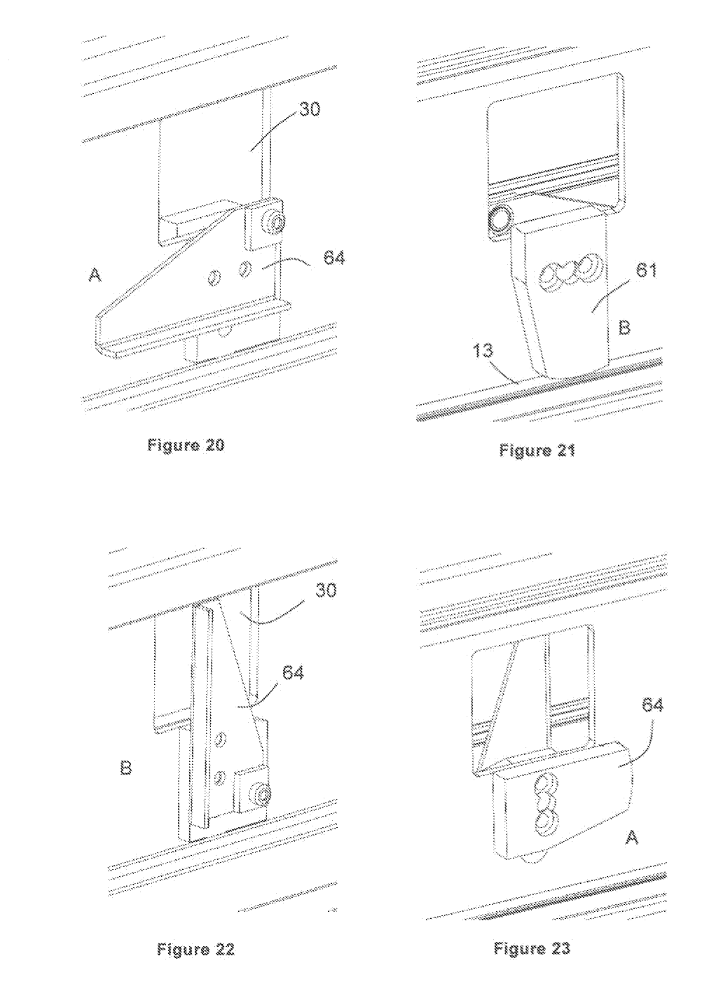

The advantage of the opening 30 in the façade element and the particular arrangement of handle 64 and locking element 61 with respect to the opening 30 is illustrated in FIGS. 20-23. In FIG. 20 the handle 64 has been pivoted to horizontal position A with the result that the first locking element 61 is in vertical position B and in full abutment with the upper side 13 of the façade element (see FIG. 21). In this situation the opening 30 is completely free of the handle 30 and a worker standing at a distance from the façade element is assured that the lifting rail 20 is firmly locked and that the façade element 10 may be safely lifted. In FIG. 22 on the other hand the handle 64 is in upright vertical position B and extends over a portion of the opening 30. The handle 36 therefore visible through the opening 30 which in turn adverts the worker that the locking element 61 is in horizontal position A and thus free of contact with the upper surface 13 of the façade element (see FIG. 23). The worker is thereby alerted that the lifting rail 20 is not locked in the upright position and that it may be hazardous to lift the façade element. Often a battery of several façade elements hanging on lifting rails is delivered to the building site (not shown). The provision of the above described opening 30 and the handle 34 makes it easy for a worker to control, by one single glance, that all lifting rails in the battery are firmly locked to their respective façade element.

The locking mechanism 60 may further comprise a second locking element 65 which is arranged on the second side 35 of the lifting rail 20. The second locking element 65 is rectangular and comprises an abutment surface 66 for abutment with the upper surface 13 of the façade element. Typically, the second locking element 65 is firmly attached to the second side 35 of the façade element and the shaft 63 extends through an opening in the second locking element 65. The provision of second locking element 65 ensures that the lifting rail remains locked in upright position even when it is subject to lateral forces, for example by a worker unintentionally stepping on lifting rail. The abutment surface 66 of the second locking element may further comprise a protrusion 67 which is configured to enter a corresponding notch in the upper surface 13 of the façade element (not shown) to ensure that the lifting rail has been properly centered.

The above embodiment describes the locking mechanism 60 in the context of a lifting rail. However, it is possible to use the locking mechanism 60 of the second embodiment in other types of rails, for example in fire protection rails or in mounting rails.

Thus, it is believed that different embodiments have been described thoroughly for purpose of illustration and description. However, the foregoing description is not intended to be exhaustive or to limit example embodiments to the precise form disclosed. Thus, modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, tools, modules and systems. It should be appreciated that any of the example embodiments presented herein may be used in conjunction, or in any combination, with one another.

It should also be noted that the word “comprising” does not necessarily exclude the presence of other elements or steps than those listed and the words “a” or “an” preceding an element do not exclude the presence of a plurality of such elements. It should further be noted that any reference signs do not limit the scope of the example embodiments and that several “means”, “units” or “tools” may be represented by the same item of hardware.

1. A façade element comprising a frame and façade material, wherein the frame is provided to surround and hold the façade material, said frame having an upper side with a length (L), wherein an elongate recess with an undercut is extending at least along a major part of the length (L) of the upper side of the frame, said recess with the undercut being adapted for receiving a lifting rail in a locking engagement.

2-4. (canceled)

5. A façade element comprising a frame and façade material, wherein the frame is provided to surround and hold the façade material, an upper part of the façade element having a length (L), said upper part being provided with a mounting area, wherein an elongate recess with an undercut is extending at least along a major part of the length (L) of the upper part of the frame, said recess with the undercut being adapted for receiving a mounting rail in a locking engagement.

6-8. (canceled)

9. A façade element comprising a frame and façade material, wherein the frame is provided to surround and hold the façade material wherein an elongate recess with an undercut is extending along a width (W) of the façade element, on the side of the façade element that is facing an interior of a building onto which the façade element is mounted, said recess with the undercut being adapted for receiving a fire protection rail in a locking engagement.

10-11. (canceled)

12. A façade element comprising a frame and façade material, wherein the frame is provided to surround and hold the façade material, said façade element having a side with a length (L) characterized in that an elongate recess with an undercut is extending at least along a portion of the length (L) of the side of the façade element, said recess with the undercut being adapted for receiving a rail in a locking engagement.

13. The façade element according to claim 12, wherein the elongate recess is extending along the entire length of the upper side of the frame.

14. The façade element according to claim 12, wherein the recess is substantially L-shaped.

15. The façade element according to claim 12, wherein the recess is substantially anchor-shaped.

16. A lifting rail for lifting a façade element, said façade element comprising a frame and façade material, wherein the frame is provided to surround and hold the façade material, said frame having an upper side with a length (L), said lifting rail comprising a L-shaped engagement portion, a shoulder and a locking mechanism, which are adapted to be received by and in locking engagement with an elongate recess of the façade element, said recess having an undercut and extending at least along a major part of the upper side of the frame, the length of the recess corresponding to a length of the lifting rail, such that when the lifting rail is in an engaged state the L-shaped engagement portion is inserted in the recess of the frame and the shoulder rests on an upper side surface at one side of the recess and the locking mechanism rests on an upper side surface at another side of the recess.

17-23. (canceled)

24. A mounting rail for retrofitting a façade element, said façade element comprising a frame and façade material, wherein the frame is provided to surround and hold the façade material, an upper part of the façade element having a length (L), said upper part being provided with a mounting area, said mounting rail comprising a L-shaped engagement portion, a shoulder and a locking mechanism, which are adapted to be received by and in locking engagement with an elongate recess of the façade element, said recess having an undercut and extending at least along a major part of the upper part of the frame, the length of the recess corresponding to a length of the mounting rail, such that when the mounting rail is in an engaged state the L-shaped engagement portion is inserted in the recess of the frame and the shoulder rests on a surface of the upper part at one side of the recess and the locking mechanism rests on a surface of the upper part at another side of the recess.

25-27. (canceled)

28. The mounting rail according to claim 24, wherein the mounting rail is provided with illumination means.

29. The mounting rail according to claim 24, wherein the mounting rail is provided with holding means adapted for receiving curtain hangers.

30. A fire protection rail for engagement with a façade element, said façade element comprising a frame and façade material, wherein the frame is provided to surround and hold the façade material, said fire protection rail comprising a L-shaped engagement portion, a shoulder and a locking mechanism, which are adapted to be received by and be in locking engagement with an elongate recess of the frame, said recess having an undercut and extending along the entire width (W) of the façade element, the length of the recess corresponding to a length of the fire protection rail, such that when the fire protection rail is in an engaged state the L-shaped engagement portion is inserted in the recess of the frame and the shoulder rests on a surface of the façade element that is facing an interior of a building onto which the façade element is to be mounted and the locking mechanism rests on the same surface, but at the opposite side of the recess.

31-34. (canceled)

35. A rail for a façade element, said façade element comprising a frame and façade material, wherein the frame is provided to surround and hold the façade material, said façade element having a side with a length (L), said rail comprising a L-shaped engagement portion, a shoulder and a locking mechanism, which are adapted to be received by and in locking engagement with an elongate recess of the façade element, said recess having an undercut and extending at least along a portion of the side of the façade element, the length of the recess corresponding to a length of the rail, such that when the rail is in an engaged state the L-shaped engagement portion is inserted in the recess of the frame and the shoulder rests on an upper side surface at one side of the recess and the locking mechanism rests on a side surface at another side of the recess.

36. The rail according to claim 35, wherein the locking mechanism is pivotable between an open position, in which the rail is insertable into the recess of the frame and a locked position, in which is the rail is in locking engagement with the recess of the frame.

37. The rail according to claim 35, wherein the locking mechanism comprises a first locking element which is pivotally attached to a first side of the rail, wherein the first locking element comprises an abutment surface for abutment with an upper side of a façade element, wherein the abutment surface is curved.

38. The rail according to claim 35, wherein the locking mechanism comprises a handle which is arranged on a second side of the lifting rail and coupled to the first locking element such that when the handle is turned to a horizontal position B, the first locking element is turned to a vertical position A for abutment with the upper surface of a façade element and such that when the handle is turned to a vertical position A, the first locking element is turned to a horizontal position A in which the locking element is free of abutment with the upper surface of a façade element.

39. The rail according to claim 35, comprising a first opening, wherein the first locking element and the handle are coupled by a shaft, wherein the shaft is arranged below the opening.

40. The rail according to claim 38, wherein the handle, when turned into vertical position A, extends over a portion of the opening.

41. The rail according to claim 36, wherein the locking mechanism is provided with a spring biased locking ball adapted to engage a cavity of the fire protection rail, when the locking mechanism is in a locked position.
